(19) United States
(12) Patent Application Publication
(10) Pub. No.: US 2005/0092942 A1
(43) Pub. Date: May 5, 2005

(54) Lamp assembly and method of converting between flood and focus conditions

(75) Inventors: James W. Schmitkons, Lorain, OH (US); Jay Wolf, Avon, OH (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 10/699,288

(22) Filed: Oct. 31, 2003

(51) Int. Cl. F21V 7/00

(52) U.S. Cl. 250/504 R

(57) ABSTRACT

A lamp assembly for irradiating a substrate is convertible between a focus condition and a flood condition. The lamp assembly includes a radiation source and a reflector having first and second pivotal reflective bodies. Each reflective body has a concave reflective surface which, together, cooperate to partially surround the radiation source. The reflective bodies can pivot to define an emission opening positioned therebetween to emit radiation from the radiation source toward the substrate. First and second movable stop members respectively engage the first and second pivotal reflective bodies during pivotal movement and each stop member is movable between first and second positions. The first position defines a focused condition of the reflective bodies and emission opening and the second position defines a flood condition of the reflective bodies and emission opening.

### FIELD OF THE INVENTION

The present invention generally relates to lamp assemblies, especially those emitting ultraviolet radiation for various industrial purposes.

### BACKGROUND OF THE INVENTION

Many applications in industry require the use of a lamp assembly which emits radiation, such as infrared or ultraviolet radiation. For example, UV light is often used to cure or otherwise treat various materials, such as UV curable adhesives used to assemble products or packaging and UV curable inks used on such products and packaging. These lamps may be microwave-powered or electrode-powered and typically include a reflector which partially surrounds an elongate lamp bulb for reflecting the ultraviolet radiation emitted by the bulb onto a substrate, such as the product or product packaging. The reflector commonly has a reflective surface which is elliptical or parabolic in shape and the lamp bulb is mounted along the symmetrical centerline and adjacent the apex of the reflector. The reflector increases the intensity of radiation received by the UV curable material and, therefore, increases the penetration of the radiation into the material.

Different UV treatment operations will often have different requirements for the radiation emission properties of the lamp assembly. Some applications will respond better if the reflector focuses the radiation at a fixed distance from the face of the lamp assembly onto a small area of the substrate. If the substrate is not adversely affected by the increased heat generated by such a focused condition, this can beneficially increase the cure rate and, therefore, increase overall productivity. In other applications, focused radiation is not a practical option because it will discolor or otherwise damage the substrate. A lamp assembly which emits de-focused radiation (i.e., a flood pattern) reduces surface temperatures on the substrate or product and can more evenly irradiate products such as three dimensional parts.

Often, a user desires to test both a focused radiation pattern and a flood radiation pattern in a particular application to determine which pattern is most suitable. Alternatively, the user may have to irradiate multiple parts with some parts being best suited for a focus lamp and some being best suited for a flood lamp. Current lamp assemblies are built to act as either a focus lamp or a flood lamp and, therefore, require that the reflector systems or bulb mountings be changed to modify the assembly between a focus and a flood type lamp. This requires significant downtime and additional expense due to the disassembly and re-assembly requirements, as well as the requirement for additional parts to make the conversion between focus and flood patterns.

For these and other reasons, it would be desirable to provide an apparatus and method which enables faster and more economical conversion of a lamp assembly between focus and flood patterns of radiation.

### SUMMARY OF THE INVENTION

The present invention provides a lamp assembly for irradiating a substrate which is easily convertible between focus and flood radiation patterns. The lamp assembly includes a radiation source and a reflector having first and second movable reflective bodies. Each reflective body has a concave reflective surface and, together, the reflective surfaces cooperate to partially surround the radiation source. The reflective bodies can move to define a variable sized emission opening positioned therebetween to emit radiation from the radiation source toward the substrate. In the preferred embodiment, first and second movable stop members respectively engage the first and second reflective bodies during their movement to provide positively defined positions. Movement of the stop members, such as by repositioning the stop members, or removal of the stop members and utilization of stop members of different size and/or position allows a flood or focus position to be selectively obtained. The positions of the reflective bodies can alternatively be obtained in other manners, such as a single stop member being used in connection with a linear actuator used to move the reflective bodies, or specialized actuators themselves being designed to effect the desired movement of the reflective bodies. In this latter regard, for example, the actuator, or multiple actuators, may be positionally controllable such as by using threaded actuating elements or by other methods.

The focus position of the first and second reflective bodies is one in which the radiation from the radiation source, such as an ultraviolet light emitting bulb, is focused at a fixed distance from the lamp assembly. The second position, which corresponds to the emission of radiation in a de-focused or flood pattern, may be one in which the radiation emission opening is smaller or larger than in the first or focused position. Preferably, the opening is smaller in the second position as this will result in a smaller overall width of the lamp assembly. The first and second reflective bodies are mounted on opposite sides of the radiation source and a third reflective body, which is preferably fixed, is mounted above the radiation source.

There can be various manners of moving the stop members of the preferred embodiment to achieve the focus and flood positions of the lamp assembly. For example, the stop members may simply be moved from one position to another or substituted with stop members of different sizes. A pair of removable stop members may define the positions for the smaller radiation emission opening, while different removable or fixed stop members may define the larger radiation emission opening. In this manner, when moving from one position to the other, the two removable stop members can simply be removed and the different stop members would then take over the stopping function. Many other movable stop member configurations, including adjustable stop members, will be readily apparent to those of ordinary skill and usable to carry out the invention.

Methods of converting a lamp assembly between a focused pattern of radiation emission onto a curing area and a flood pattern of radiation emission onto the curing area are also provided by the invention. The methods can generally use the structure summarized above and can include moving the first and second movable reflective bodies in respective paths of movements relative to the radiation source and, preferably, against respective first and second stop members to define a focus position of the reflective bodies. A first amount of radiation is emitted from the radiation source and then reflected off the reflective bodies and toward the curing area in the focused pattern. The first and second reflective bodies are then moved relative to the radiation source to new positions. These new positions can define a flood position of the reflective bodies. To achieve the new positions, for example, the first and second stop members are moved out of the paths of movement of the reflective bodies. A second amount of radiation is then emitted from the radiation source and reflected off the reflective bodies toward the curing area in the flood pattern. The method further contemplates the reverse of this process, that is, reflecting the radiation off the reflective bodies first in a flood pattern and, after repositioning the first and second reflective bodies, reflecting the radiation off the reflective bodies in the focused pattern. The curing area may or may not contain a substrate depending on the application. For example, a substrate may not be in the curing area if a test of the flood and focus patterns is being conducted which does not require a substrate.

The present invention provides a simple, cost effective manner for achieving either a flood or focus pattern of radiation in a particular application depending on the needs of that particular application. It can also be adapted to handle multiple parts in succession which require different patterns of radiation. These and other features, objects and advantages of the invention will become more readily apparent to those of ordinary skill in the art upon review of the following detailed description, taken in conjunction with the accompanying drawings.

### BRIEF DESCRIPTION OF DRAWINGS

FIG. 1 is a perspective view of a lamp assembly constructed in accordance with the invention.

FIG. 2 is a perspective view of the lamp assembly of FIG. 1, from an opposite direction, and partially sectioned to show adjustment structure associated therewith.

FIG. 3 is an end view taken along line 3-3 of FIG. 2, and showing a flood position of the first and second reflective bodies.

FIG. 4 is an end view similar to FIG. 3, but showing a focused position of the first and second reflective bodies.

FIG. 5 is a schematic end view similar to FIG. 3 but illustrating an alternative type of stop member configuration.

FIG. 6 is a schematic end view similar to FIG. 4 but illustrating another position of the stop members shown in FIG. 5.

FIG. 7 is an end view similar to FIGS. 3 and 4, but showing a shuttered position of the first and second reflective bodies.

### DETAILED DESCRIPTION OF PREFERRED EMBODIMENTS

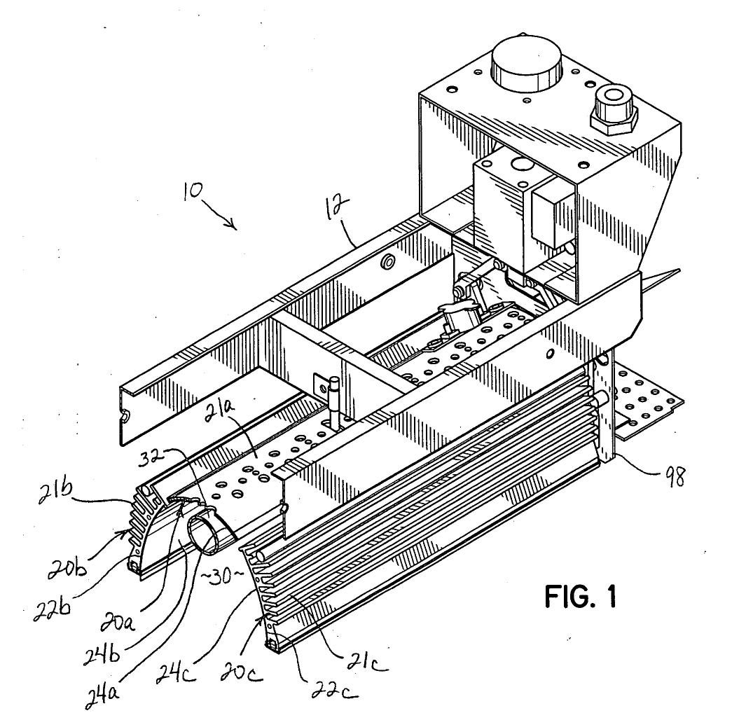

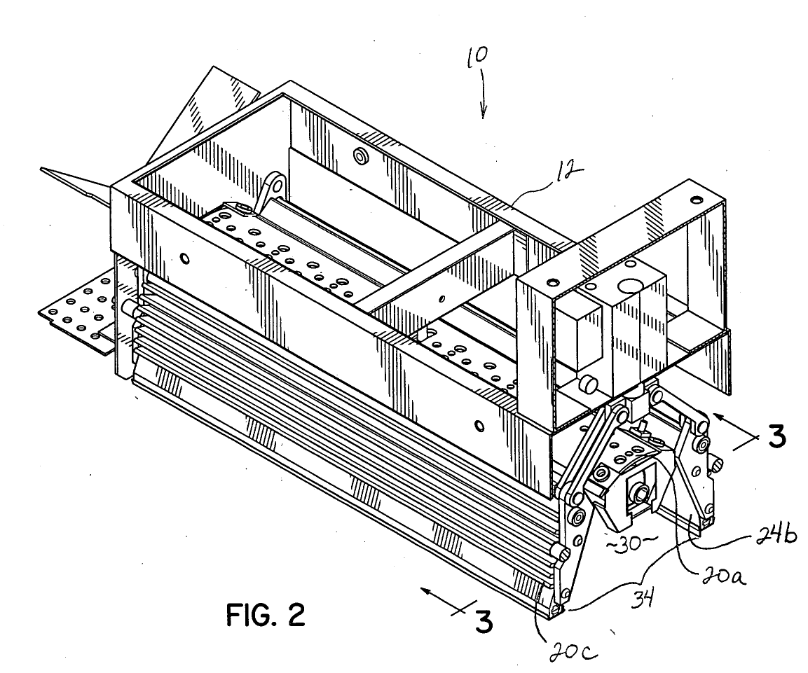

FIGS. 1 and 2 respectively illustrate perspective views of a partially disassembled electrode lamp assembly 10 for emitting UV radiation. For clarity; these drawing figures do not illustrate a housing and various other conventional structure normally associated with such lamp assemblies. However, a suitable lamp assembly useful for incorporating the present invention is an industrial electrode lamp available from Nordson Corporation, Westlake, Ohio. Support structure 12 is shown for a reflector 20 which comprises three reflector bodies 20a, 20b, 20c. Reflector body 20a is centrally located and fixed in place and a pair of reflector bodies 20b, 20c are located on opposite sides of the central reflector body 20a and are pivotal for position adjustment purposes as will be discussed in more detail below. The two pivotal reflective bodies 20b, 20c are formed as extrusions 21b, 21c with concave inner surfaces 22b, 22c which receive respective reflector panels 24b, 24c which may, for example, be formed of highly polished aluminum or other similar reflective material, or materials coated with a reflective or dichroic material. Central reflective body 20a is formed using a rigid support member 21a of concave shape receiving a similarly shaped reflective panel or skin 24a having reflective properties similar to panels 24b, 24c. Together, the three reflective bodies 20a, 20b, 20c form an elliptical shape around a cavity 30.

A lamp bulb 32 is mounted in the cavity 30 for emitting radiation down onto a substrate (not shown) positioned below the assembly 10. Specifically, the radiation from the lamp bulb 32 passes through an emission opening 34. Radiation emitted from the bottom of the lamp bulb 32 is directly transmitted to the substrate while radiation emitted from the sides and the top of the lamp bulb 32 reflects off the reflective bodies 20a, 20b, 20c before hitting the substrate. The reflective panels 24b, 24c of the pair of adjustable reflective bodies 20b, 20c are held in place between respective flanges (not shown) of the extrusions 21b, 21c and clamps (40, 42 fixed to the extrusions at the lower ends of the concave surfaces by bolts 48, 50.

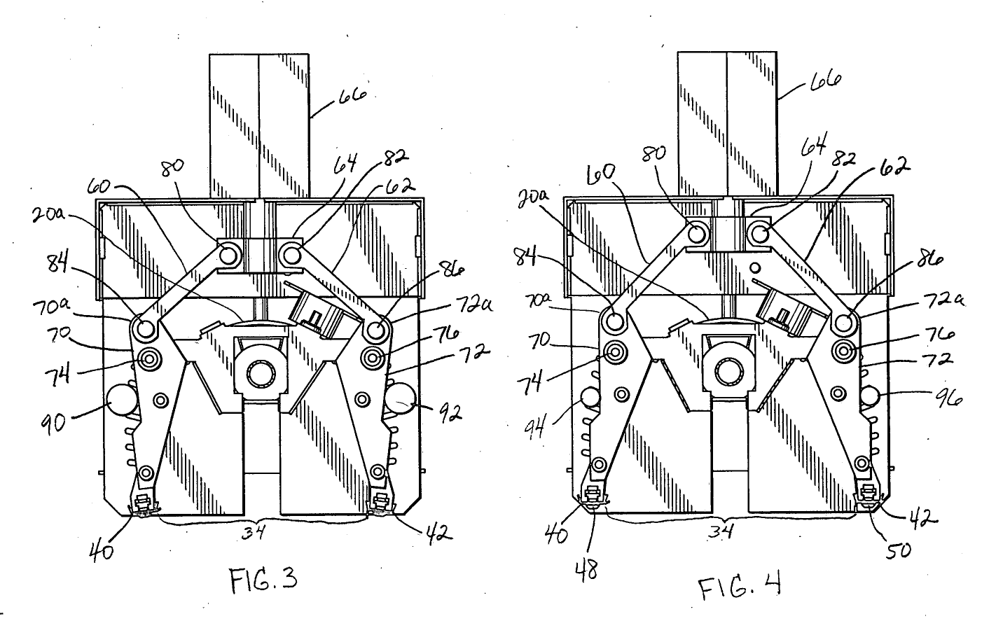

A pair of linkage assemblies 60, 62, as best shown in FIGS. 3 and 4 are coupled between a reciprocating element 64 of an pneumatically operated linear actuator 66 (e.g., an air cylinder) and upper ends 70a, 72a of mounting flanges 70, 72 coupled with pivotal reflective bodies by respective pivot connections 74, 76 which define respective pivot axes at their centers of rotation. Upper and lower pivot connections 80, 82, 84, 86 are formed between a reciprocating element 64 of the actuator 66 and the respective flanges 70, 72 associated with the reflective bodies 20b, 20c. As shown in FIGS. 3 and 4, different pairs of stop members 90, 92 (FIG. 3) and 94, 96 (FIG. 4) are provided for limiting the outward pivotal movement of the flanges 70, 72 and, therefore, limiting the outward pivotal movement of the reflective bodies 20b, 20c. Stop members 90, 92 and 94, 96 may be threaded pins which are removably secured to suitable support structure 98. (FIG. 1) associated with the lamp assembly 10. Pins 90, 92 and 94, 96 have a diameter associated with the desired stopping position and, therefore, associated with the desired overall elliptical shape formed by the panels 24a, 24b, 24c of the reflective bodies 20a, 20b, 20c when the adjustable, outer reflective bodies 20b, 20c are moved to the extreme outer position determined by the pins 90, 92 or 94, 96. In the embodiment shown, pins 90, 92 cause panels 24a, 24b, 24c to assume a flood pattern shape, while pins 94, 96 cause panels 24a, 24b, 24c to assume a focus pattern shape. Thus, assembly 10 may be changed between flood and focus patterns simply by changing out one pair of pins 90, 92 for the other pair 94, 96 or vice versa. It will be appreciated that other types of actuators and actuating system configurations may be used instead of the one shown.

As shown in FIG. 3, which corresponds to the flood position, the reciprocating element 64 has moved the outer reflective bodies 20b, 20c to a maximum outward position which creates a relatively narrow cavity 30 and emission opening 34. On the other hand, when pins 94, 96 of a smaller diameter are used, the reciprocating element 64 can move further inward and this results in a wider cavity 30 and larger emission opening 34 of a shape normally used for establishing a focused pattern of radiation as shown in FIG. 4.

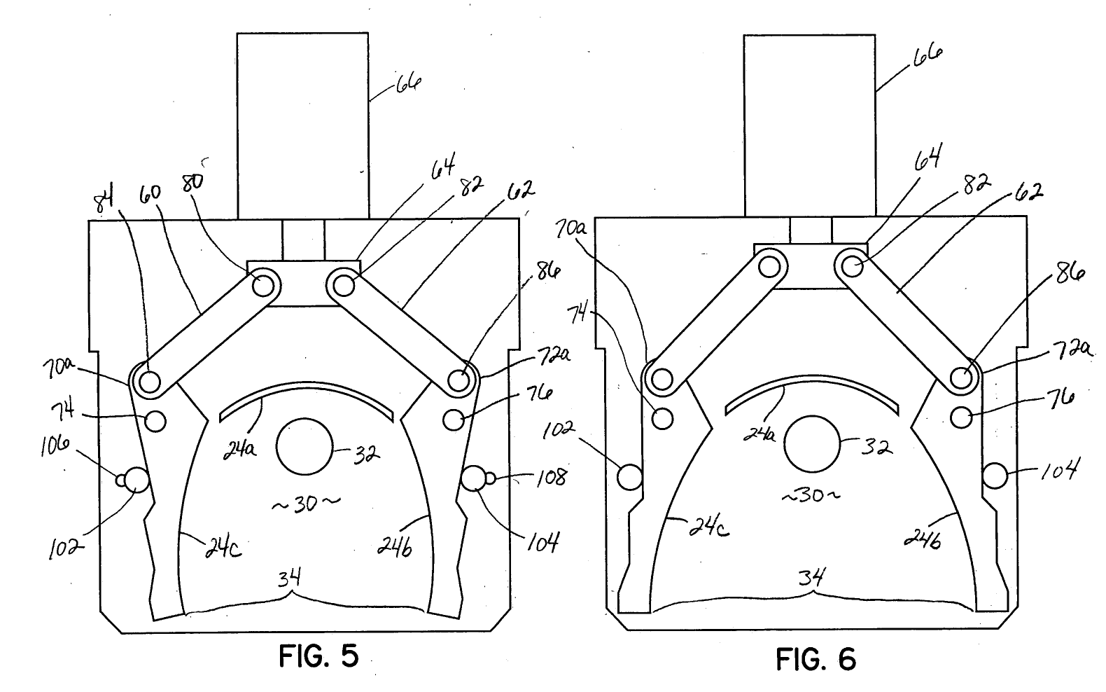

FIGS. 5 and 6 illustrate schematic end or cross sectional views similar to FIGS. 3 and 4, but illustrating a different type of adjustment mechanism which is just one of many potential adjustment mechanisms which may be used as an alternative to the different diameter pins shown in FIGS. 3 and 4. Like reference numerals refer to corresponding structure to the first embodiment, although depicted more schematically in FIGS. 5 and 6. In this second embodiment, the same diameter pins are used but may be threaded into holes located in the support structure at different locations corresponding to the flood and focus positions of the assembly. FIG. 5 illustrates the flood position of pins 102, 104 which form a narrower cavity and radiation emission opening, while FIG. 6 illustrates the alternative outer positions of pins 102, 104 for establishing a focus position of the reflective panels. Thus, by simply unthreading pins 102, 104 from the positions shown in FIG. 5 and threading the pins 102, 104 into the more outwardly located threaded holes 106, 108 shown in FIG. 5, the lamp assembly 10 may be easily and quickly changed between the flood and focus positions shown respectively in FIGS. 5 and 6.

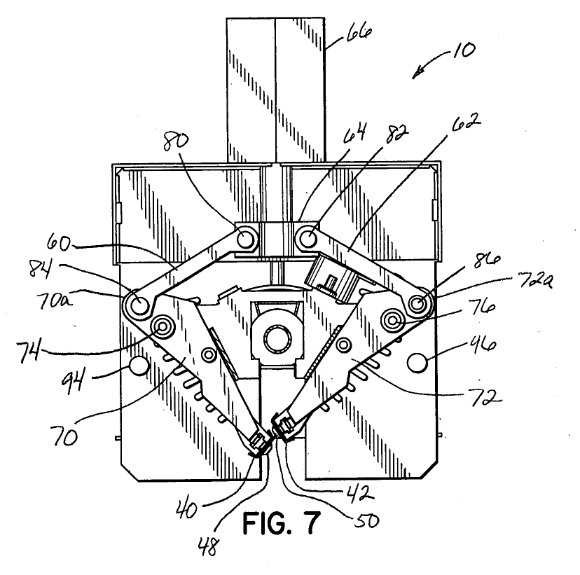

As further shown in FIG. 7, the reciprocating element 64 may be fully extended by the actuator 66 to essentially close the radiation emission opening 34 thereby shuttering or closing off the emission of radiation from the lamp bulb 32.

While the present invention has been illustrated by a description of various preferred embodiments and while these embodiments has been described in some detail, it is not the intention of the Applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims, wherein what is claimed is:

1. A lamp assembly for irradiating a substrate, comprising:
a radiation source,
a reflector having first and second movable reflective bodies each having a concave reflective surface, said first and second reflective bodies cooperating to partially surround said radiation source and being movable to define an emission opening positioned therebetween to emit radiation from said radiation source toward the substrate, and
first and second movable stop members positioned to respectively engage said first and second reflective bodies during movement thereof, each stop member being movable to selectively enable radiation from said radiation source to be emitted through said emission opening selectively either in a focused pattern or a flood pattern.

2. The lamp assembly of claim 1, further comprising:
third and fourth stop members positioned to either reduce or enlarge said emission opening.

3. The lamp assembly of claim 2, wherein said first, second, third and fourth stop members comprise pins, said first and second pins having smaller diameters than said third and fourth pins.

4. The lamp assembly of claim 1, wherein said first and second reflective bodies are mounted on opposite sides of said radiation source and further comprising a third reflective body mounted above said radiation source.

5. The lamp assembly of claim 1, wherein said first and second reflective bodies move in respective paths of movement and said first and second movable stop members are removable from the respective paths of movement to enable a different amount of movement of said first and second reflective bodies.

6. The lamp assembly of claim 5, wherein said first and second movable stop members are fixable at different locations along the respective paths of movement.

7. The lamp assembly of claim 1, wherein said radiation source further comprises an elongate ultraviolet light emitting bulb.

8. A lamp assembly for irradiating a substrate, comprising:
a radiation source,
a reflector having first and second movable reflective bodies each having a concave reflective surface, said first and second reflective bodies cooperating to partially surround said radiation source and being movable to define an emission opening positioned therebetween to emit radiation from said radiation source toward the substrate, and
an actuating system coupled to said first and second reflective bodies and configured to effect movement thereof between at least first and second positions, said first position placing said first and second reflective bodies at a first spaced apart width and causing radiation from said radiation source to be emitted through said emission opening in a focused pattern and said second position placing said first and second reflective bodies at a second spaced apart width and causing radiation from said radiation source to be emitted through said emission opening in a flood pattern,
wherein said first spaced apart width is greater than said second spaced apart width.

9. A method of converting a lamp assembly from a focused pattern of radiation emission onto a curing area to a flood pattern of radiation emission onto the wring area, the lamp assembly comprising a radiation source and first and second movable reflective bodies partially surrounding the radiation source, and first and second stop members, the method comprising:
moving the first and second movable reflective bodies in respective paths of movement relative to the radiation source and against respective first and second stop members to define a focus position of the reflective bodies,
emitting a first amount of radiation from the radiation source, reflecting the first amount of radiation off the reflective bodies and toward the curing area in the focused pattern,
moving the first and second stop members out of the paths of movement,
moving the first and second reflective bodies relative to the radiation source to positions allowed by the movement of the first and second stop members and defining a flood position of the reflective bodies,
emitting a second amount of radiation from the radiation source, and
reflecting the second amount of radiation off the reflective bodies and toward the curing area in the flood pattern.

10. The method of claim 9, wherein the lamp assembly further comprises third and fourth stop members, wherein moving the first and second stop members further comprises:
removing the first and second stop members, and
stopping the first and second reflective bodies against the respective third and fourth stop members at the flood position.

11. The method of claim 10, wherein stopping the first and second reflective bodies against the respective third and fourth stop members further comprises:
moving the first and second reflective bodies closer together.

12. The method of claim 10, wherein stopping the first and second reflective bodies against the respective third and fourth stop members further comprises:
moving the first and second reflective bodies farther apart.

13. A method of converting a lamp assembly between a focused pattern of radiation emission onto a curing area and a flood pattern of radiation emission onto the curing area, the lamp assembly comprising a radiation source and first and second movable reflective bodies partially surrounding the radiation source, and first and second stop members, the method comprising:
moving the first and second movable reflective bodies in respective paths of movement relative to the radiation source and against respective first and second stop members to define a flood position of the reflective bodies,
emitting a first amount of radiation from the radiation source,
reflecting the first amount of radiation off the reflective bodies and toward the curing area in the flood pattern,
moving the first and second stop members out of the paths of movement,
moving the first and second reflective bodies relative to the radiation source to positions allowed by the movement of the first and second stop members and defining a focus position of the reflective bodies,
emitting a second amount of radiation from the radiation source, and
reflecting the second amount of radiation off the reflective bodies and toward the curing area in the focused pattern.

14. The method of claim 13, wherein the lamp assembly further comprises third and fourth stop members, wherein moving the first and second stop members further comprises:
removing the first and second stop members, and
stopping the first and second reflective bodies against the respective third and fourth stop members at the focus position.

15. The method of claim 14, wherein stopping the first and second reflective bodies against the respective third and fourth stop members further comprises:
moving the first and second reflective bodies closer together.

16. The method of claim 14, wherein stopping the first and second reflective bodies against the respective third and fourth stop members further comprises:
moving the first and second reflective bodies farther apart.

17. A method of converting a lamp assembly between a focused pattern of radiation emission onto a curing area and a flood pattern of radiation emission onto the curing area, the lamp assembly comprising a radiation source and first and second movable reflective bodies partially surrounding the radiation source, the method comprising:
moving the first and second movable reflective bodies in respective paths of movement relative to the radiation source to define a focus position of the reflective bodies at a first spaced apart width,
emitting a first amount of radiation from the radiation source,
reflecting the first amount of radiation off the reflective bodies and toward the curing area in the focused pattern,
moving the first and second reflective bodies relative to the radiation source to positions defining a flood position of the reflective bodies at a second spaced apart width smaller than the first spaced apart width,
emitting a second amount of radiation from the radiation source, and
reflecting the second amount of radiation off the reflective bodies and toward the curing area in the flood pattern.
